(19) United States
(12) Patent Application Publication
(10) Pub. No.: US 2008/0316932 A1
(43) Pub. Date: Dec. 25, 2008

(54) Identifying method for network device

(75) Inventor: Jiunn-Chen Lin, Hsinchu County (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/889,957

(22) Filed: Aug. 17, 2007

(30) Foreign Application Priority Data
Jun. 21, 2007 (TW) 096122357

(51) Int. Cl. H04L 1/00

(52) U.S. Cl. 370/248

(57) ABSTRACT

An identifying method includes the following steps. First, a network device automatically retrieves a network address as the address thereof. Then, a testing host transmits at least one network protocol package to the network device. The network protocol package includes a network protocol header and the network protocol data, which defines the address of the network device. Accordingly, the testing host can identify the network device according to the address of the network device.

### BACKGROUND OF THE INVENTION

1. Field of Invention

The invention relates to an identifying method and, in particular, to an identifying method for a network device.

2. Related Art

With the rapid development in network technology, people can share and transmit a huge amount of multimedia information through network devices, such as access points, gateways, and routers.

Generally speaking, either before a network device is shipped out or sent back for maintenance, it is usually provided with a testing port, such as the serial port, universal asynchronous receiver transmitter (UART), or RS232 for testing the operations thereof. For example, the manufacturer uses an RS232 line to electrically connect a testing host and the testing port of a network device. The testing host then communicates with the network device through the RS232 line, checking the operations thereof in order to find out its performance or problem. The information is used for subsequent debugging.

Since the network device is provided with the testing port, other manufacturers or users can readily obtain the internal settings thereof through the port. Thus, the design of the network device may be pirated because of this insecurity.

Once the testing port of a network device is removed, it is difficult for the manufacturer to use a testing host to test the network device via a wireless network. This is because the testing host does not know the network address of the network device. Therefore, the testing host cannot communicate with the network device for subsequent testing.

Therefore, it is an important subject of the invention to provide an identifying method that can communicate and identify the network device without using a testing port.

### SUMMARY OF THE INVENTION

In view of the foregoing, the invention is to provide an identifying method for testing a network device without using a testing port.

To achieve the above, the invention discloses an identifying method applied to at least a network device and a testing host. The identifying method includes the following steps of automatically retrieving a network address by the network device and transmitting at least a network protocol packet to the network device by the testing host. The retrieved network address is designated as an address of the network device. The network protocol packet includes a network protocol header and a network protocol data, which at least defines the address of the network device. Then, the testing host identifies the network device according to the address defined in the network protocol data.

In addition, the invention also discloses an identifying method applied to a plurality of network devices and a testing host. The identifying method includes the steps of automatically receiving a network address by each of the network devices and transmitting at least one network protocol packet to each of the network devices by the testing host. Herein, each of the retrieved network addresses is designated as an address of each of the network devices. Each of the network protocol packets includes a network protocol header and a network protocol data, which at least defines the address of the corresponding network device. Then, the testing host identifies each of the network device according to the address defined in each of the network protocol data.

As mentioned above, according to the identifying method for network devices of the invention, each of the network devices automatically retrieves a network address as its address, and a testing host transmits at least one network protocol packet to the network device. The testing host then enables the CLI of the network device according to the received network address for performing a reading, writing, controlling, diagnosing, or debugging command. The testing host can thus check the internal settings of each network device. The network devices do not require a testing port as in the prior art, preventing the design of network devices from being pirated through the testing port. This improves the security of network devices.

### BRIEF DESCRIPTION OF THE DRAWINGS

The invention will become more fully understood from the detailed description given herein below illustration only, and thus is not limitative of the present invention, and wherein:

FIG. 1 is a flowchart of an identifying method for network devices according to a first embodiment of the invention;

FIG. 2 is a flowchart of an identifying method for network devices according to a second embodiment of the invention; and

FIG. 3 is a flowchart of an identifying method for network devices according to the second embodiment of the invention, cooperating with three network devices.

### DETAILED DESCRIPTION OF THE INVENTION

The present invention will be apparent from the following detailed description, which proceeds with reference to the accompanying drawings, wherein the same references relate to the same elements.

### First Embodiment

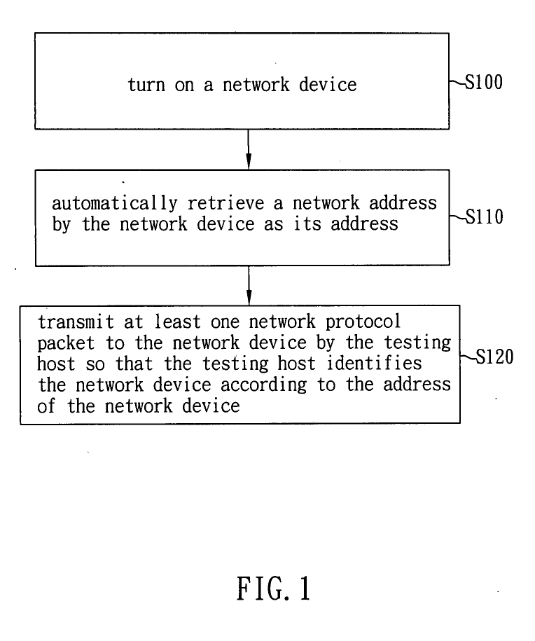

As shown in FIG. 1, an identifying method according to a first embodiment of the invention is applied to a network device and a testing host. In the embodiment, the network device is, for example, a wireless network device. The identifying method includes the following steps S100 to S120.

In step S100, the network device is turned on for communicating with the environment.

In step S110, the network device automatically retrieves a network address as its address. In practice, the network device identifies several unused network addresses and then selects one from them as its address in the network. In this embodiment, the network address is an Internet protocol (IP) address.

In step S120, the testing host transmits at least one network protocol packet to the network device. In the embodiment, the network protocol packet includes a network protocol header and a network protocol data. The network protocol data at least defines the address of the network device, so that the testing host can identify the network device accordingly.

In this embodiment, the network protocol packet is an ICMP packet, the network protocol header is an ICMP header, and the network protocol data is an ICMP data.

As mentioned above, the network device of the embodiment can automatically retrieve a network address as its address. Afterwards, a network protocol packet is transmitted to the network device by a testing host, so that the testing host can identify the network address accordingly. Subsequently, the testing host can enable the command line interface (CLI), reading, writing, controlling, diagnosing, and debugging commands of the network device, testing the internal settings of the network device. Therefore, the network device does not require a testing port as in the prior art. As a result, the design of the network device can be prevented from being pirated for a higher security.

The above-mentioned identifying method uses a single network device as an example. It tests only one network device in one testing cycle. The identifying method for testing several network devices in one testing cycle will be described herein below.

### Second Embodiment

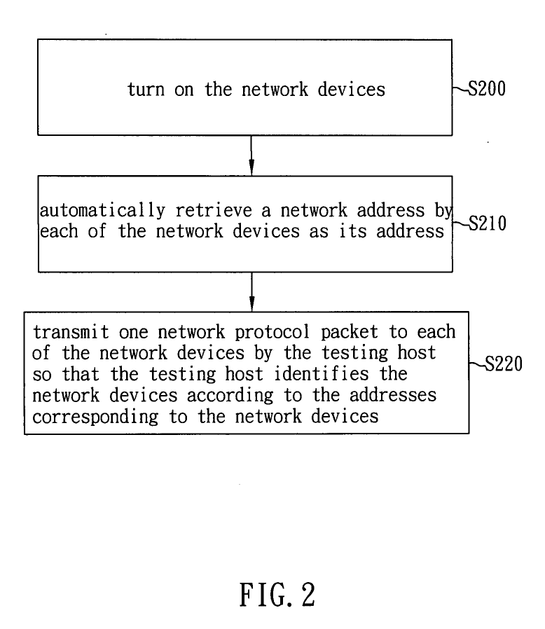

As shown in FIG. 2, an identifying method according to a second embodiment of the invention is applied to several network devices and a testing host. The network devices are, for example, wireless network devices. The identifying method at least includes the following steps S200 to S220.

In step S200, the network devices are turned on for communicating with the environment.

In step S210, each of the network devices automatically retrieves a network address as its address. In practice, each network device finds several unused network addresses and then selects one of them as its address. In this embodiment, the network addresses are IP addresses.

In step S220, the testing host transmits at least one network protocol packet to each of the network devices. Each network protocol packet includes a network protocol header and a network protocol data. The network protocol data at least defines the address of the corresponding network device, so that the testing host can identify the network devices accordingly.

In this embodiment, the network protocol packet is an ICMP packet, the network protocol header is an ICMP header, and the network protocol data is an ICMP data.

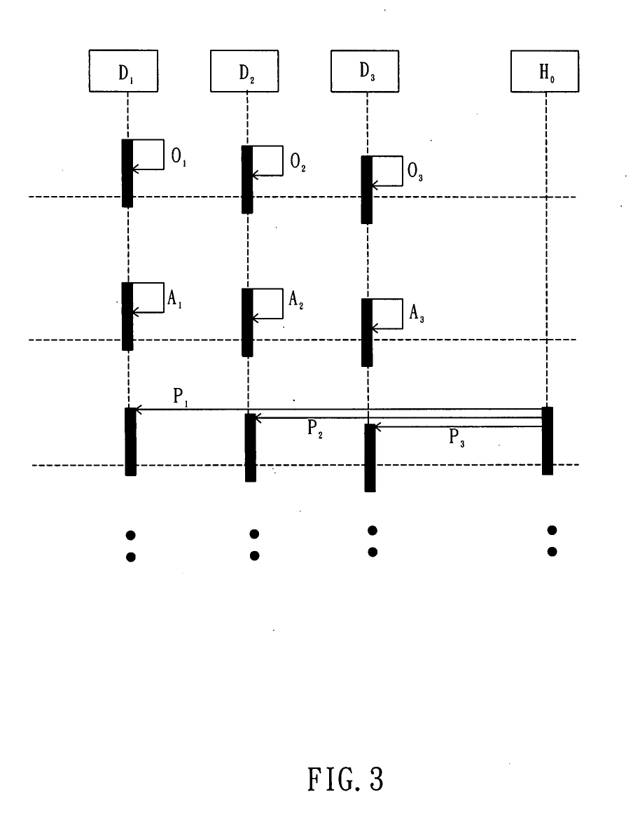

The following uses three network devices as an example to explain the identifying method according to the second embodiment. As shown in FIG. 3, the power O₁ of the first network device D₁, the power O₂ of the second network device D₂, and the power O₃ of the third network device D₃ are turned on for communicating with the environment.

Then, the first network device D₁ automatically retrieves a network address A₁ (e.g., 192.168.1.1) as its address. Afterwards, when the second network device D₂ finds out that the network address of 192.168.1.1 has been used, it keeps scanning to retrieve another network address A₂ (e.g., 192.168.1.2) as its address. When the third network device D₃ finds out that the network addresses of 192.168.1.1 and 192.168.1.2 have been used, it keeps scanning to retrieve an unused network address A₃ (e.g., 192.168.1.3) as its address.

Afterwards, a testing host H₀ transmits network protocol packets P₁, P₂ and P₃ to the first network device D₁, the second network device D₂ and the third network address D₃ respectively. Each of the network protocol packets P₁, P₂ and P₃ has a network protocol header and a network protocol data. The network protocol data at least defines the address of corresponding one of the network devices D₁, D₂ and D₃. Therefore, the testing host H₀ can identify the network devices according to their addresses, and then the testing host H₀ can enable the CLIs of the network devices for performing the reading, writing, controlling, diagnosing or debugging command so as to check the internal settings of the network devices.

In summary, according to the identifying method for network devices of the invention, each of the network devices automatically retrieves a network address as its address, and the testing host transmits at least one network protocol packet to each of the network devices. The testing host then enables the CLI of the network device according to the received network address for performing a reading, writing, controlling, diagnosing, or debugging command. The testing host can thus check the internal settings of each network device. The network devices do not require a testing port as in the prior art, preventing the design of network devices from being pirated through the testing port. This improves the security of network devices.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An identifying method applied to at least a network device and a testing host, the identifying method comprising the steps of:
automatically retrieving a network address by the network device, wherein the retrieved network address is designated as an address of the network device; and
transmitting at least a network protocol packet to the network device by the testing host;
wherein the network protocol packet comprises a network protocol header and a network protocol data at least defining the address of the network device, and the testing host identifies the network device according to the address defined in the network protocol data.

2. The identifying method according to claim 1 further comprising, before the step of automatically retrieving the network address by the network device, the step of:
turning on the network device.

3. The identifying method according to claim 1, wherein the network address is an Internet protocol (IP) address.

4. The identifying method according to claim 1, wherein the network protocol package is an Internet Control Message Protocol (ICMP) package.

5. The identifying method according to claim 1, wherein the network protocol header is an ICMP header and the network protocol data is an ICMP data.

6. The identifying method according to claim 1, wherein the network device is a wireless network device.

7. An identifying method applied to a plurality of network devices and a testing host, the identifying method comprising the steps of:
automatically receiving a network address by each of the network devices, wherein each of the retrieved network addresses is designated as an address of each of the network devices; and
transmitting a network protocol packet to each of the network devices by the testing host;
wherein each of the network protocol packets comprises a network protocol header and a network protocol data at least defining the address of the corresponding network device, and the testing host identifies each of the network device according to the address defined in each of the network protocol data.

8. The identifying method according to claim 7 further comprising, before the step of automatically retrieving the network address by each of the network devices, the step of:
turning on the network devices.

9. The identifying method according to claim 7, wherein each of the network addresses is an Internet protocol (IP) address.

10. The identifying method according to claim 7, wherein each of the network protocol packages is an Internet Control Message Protocol (ICMP) package.

11. The identifying method according to claim 7, wherein the network protocol header is an ICMP header and the network protocol data is an ICMP data.

12. The identifying method according to claim 7, wherein each of the network devices is a wireless network device.
